(19) United States
(12) Patent Application Publication
(10) Pub. No.: US 2025/0380121 A1
(43) Pub. Date: Dec. 11, 2025

(54) EMERGENCY CALL SYSTEM AND METHOD BASED ON WIRELESS COMMUNICATION

(71) Applicants: Hyundai Motor Company, Seoul (KR); Kia Corporation, Seoul (KR)

(72) Inventors: Xu Qiang Sun, Shandong (CN); Hui Xie, Shandong (CN)

(21) Appl. No.: 19/196,115

(22) Filed: May 1, 2025

(30) Foreign Application Priority Data
Jun. 5, 2024 (CN) 202410725094.2

(51) Int. Cl. H04W 4/90; B60N 2/00; B60Q 1/52; B60Q 5/00; B60R 16/023; G07C 5/00

(52) U.S. Cl. CPC H04W 4/90; B60Q 1/52; B60Q 5/005; G07C 5/008; B60N 2/002; B60R 16/0231

(57) ABSTRACT

An emergency call system and method are based on wireless technology such as ultra-wideband (UWB). The emergency call system includes a mobile device including a communication module for transmitting and receiving a communication signal, an on-vehicle communication device including a processing module and a plurality of on-board communication modules, a vehicle speed detection device configured to detect a vehicle speed, and a main control device communicatively connected to the on-vehicle communication device and the vehicle speed detection device, where the main control device is configured to determine whether an emergency situation occurs based on position change information of the mobile device and a change of the vehicle speed, and send an alarm signal from a vehicle when it is determined that the emergency situation has occurred.

### CROSS-REFERENCE TO RELATED APPLICATION

This application claims under 35 U.S.C. § 119 (a) the benefit of Chinese Patent Application No. 202410725094.2 filed with the Chinese Intellectual Property Office on Jun. 5, 2024, the entire contents of which are incorporated herein by reference.

### BACKGROUND

### (a) Technical Field

The present disclosure relates to an emergency call system and method based on wireless communication, more particularly, to the emergency call system and method that utilize ultra-wideband (UWB) communication.

### (b) Description of the Related Art

In conjunction with the intelligent development of vehicles, demands for safety and convenience are also continuously increasing. One important element related to vehicle safety is quickly and accurately sending distress signals in emergency situations so that help can be provided in a timely manner.

A current emergency call system may provide rescue services to vehicle drivers in the event of an emergency situation, and is a system that automatically sounds an alarm through sensor detection in the event of an accident or is triggered by users manually calling during an emergency. However, when no airbag is deployed in the event of an emergency, the emergency call system may not automatically request rescue, or it may be inconvenient for drivers to manually request rescue. In addition, no emergency call system is installed in certain vehicles, or drivers do not know how to use the emergency call system, which makes emergency rescue operations difficult or impossible.

Therefore, a more intelligent emergency call method is required to provide safer and more convenient rescue services to drivers and passengers by taking prompt actions when necessary.

The matters described in the Background section are drafted to enhance the understanding of the background of the disclosure, and may include matters that are not already known to those of ordinary skill in the art to which this technology pertains.

### SUMMARY

The present disclosure provides an emergency call system and method based on wireless technology, preferably ultra-wideband (UWB) communication, capable of determining whether an emergency situation occurs by combining vehicle information with a sudden movement of a mobile device in a vehicle detected through UWB communication. In the event of the emergency situation, the vehicle sends an alarm signal. In addition, the vehicle may send relevant information to the mobile device and automatically request an alert and rescue, thereby effectively improving the safety of the vehicle and providing a more convenient and intelligent driving experience to a user.

According to an embodiment of the present disclosure, an emergency call system based on wireless technology includes: a mobile device including a communication module and capable of transmitting and receiving a communication signal; a vehicle including an on-vehicle communication device including a processing module and a plurality of on-board communication modules; a vehicle speed detection device configured to detect a vehicle speed; and a main control device communicatively connected to the on-vehicle communication device and the vehicle speed detection device, wherein the main control device is configured to determine whether an emergency situation occurs based on position change information of the mobile device and a change of the vehicle speed, and send an alarm signal from the vehicle when it is determined that the emergency situation has occurred.

According to an aspect of the present disclosure, an emergency call system based on an ultra-wideband (UWB) is provided. The emergency call system based on UWB includes a mobile device including a UWB communication module and capable of transmitting and receiving a UWB communication signal, an on-vehicle UWB communication device including a UWB processing module and a plurality of on-board UWB communication modules, a vehicle speed detection device configured to detect a vehicle speed, and a main control device communicatively connected to each of the on-vehicle UWB communication device and the vehicle speed detection device, wherein the UWB processing module is configured to be communicatively connected to the plurality of on-board UWB communication modules, the plurality of on-board UWB communication modules is configured to perform UWB communication with the mobile device, and sends the received UWB communication signal of the mobile device to the UWB processing module, the UWB processing module is configured to detect position information of the mobile device based on the received UWB communication signal of the mobile device, and determine position change information of the mobile device according to the detected position information of the mobile device, and wherein the main control device is configured to determine whether an emergency situation occurs based on the position change information of the mobile device and a change of the vehicle speed, and send an alarm signal from a vehicle when it is determined that the emergency situation has occurred.

The emergency call system may further include an airbag detection device communicatively connected to the main control device and configured to detect whether an airbag is deployed, and the main control device may be further configured to: when the airbag is deployed, determine that the emergency situation has occurred, and when the airbag is not deployed, determine that the emergency situation has occurred when the position change information of the mobile device is greater than or equal to a first predetermined threshold value and the change of the vehicle speed is greater than or equal to a second predetermined threshold value.

The emergency call system may further include a positioning device configured to detect position information of a vehicle, a vehicle external temperature and humidity detection device configured to detect vehicle external temperature information and vehicle external humidity information, an on-board camera configured to detect environment information around the vehicle, and a seat boarding detection device configured to detect information of the number of passengers, wherein the main control device may be communicatively connected to the positioning device, the vehicle external temperature and humidity detection device, and the on-board camera, and electrically connected to the seat boarding detection device, and wherein the main control device may be further configured to obtain at least one of the position information of the vehicle, the vehicle external temperature information, the vehicle external humidity information, the environment information around the vehicle, or the information of the number of passengers when it is determined that the emergency situation has occurred, and send at least one of the obtained position information of the vehicle, the obtained vehicle external temperature information, the obtained vehicle external humidity information, the obtained environment information around the vehicle, or the obtained information of the number of passengers to the mobile device by the on-vehicle UWB communication device.

The emergency call system may further include an on-board display device communicatively connected to the main control device and configured to display prompt information about whether to make an emergency call to a driver when it is determined that the emergency situation has occurred, and when no emergency call is not selected within a predetermined time, the main control device may be further configured to allow the mobile device to send the emergency call to a rescue center and send at least one of the obtained vehicle position information, the obtained vehicle external temperature information, the obtained vehicle external humidity information, the obtained environment information around the vehicle, or the obtained information of the number of passengers together to the rescue center.

The emergency call system may further include an audio device communicatively connected to the main control device and configured to play audio, and when it is determined that the emergency situation has occurred, the main control device may be further configured to detect whether the audio device is operating, and when it is detected that the audio device is operating, turn off the audio device.

The emergency call system may further include at least one of a buzzer, a warning lamp, or a horn electrically connected to the main control device, and the main control device may be further configured to operate at least one of the buzzer, the warning light, or the horn when it is determined that the emergency situation has occurred.

The number of the plurality of on-board UWB communication modules may be five, and the five on-board UWB communication modules may be provided at a left front portion, a right front portion, a left rear portion, a right rear portion, and a position of a roof close to a front of the vehicle, respectively.

A communicable connection may include a connection in a wired communication manner, and the wired communication manner may include a controller area network (CAN), a universal serial bus (USB), and a digital visual interface (DVI).

According to an embodiment of the present disclosure, an emergency call method based on wireless technology includes: transmitting and receiving, by a mobile device, a communication signal; detecting, based on the received communication signal of the mobile device by an on-vehicle communication device provided in a vehicle, position information of the mobile device; determining, by the on-vehicle communication device, position change information of the mobile device according to the detected position information of the mobile device; detecting, by a vehicle speed detection device, a vehicle speed; determining, by a main control device, whether an emergency situation occurs based on the position change information of the mobile device and a change of the vehicle speed; and sending, by the main control device, an alarm signal from the vehicle when it is determined that the emergency situation has occurred.

According to another aspect of the present disclosure, an emergency call method based on UWB is provided. The emergency call method based on UWB may include transmitting and receiving, by a mobile device, a UWB communication signal, detecting, based on the received UWB communication signal of the mobile device by an on-vehicle UWB communication device, position information of the mobile device, determining, by the on-vehicle UWB communication device, position change information of the mobile device according to the detected position information of the mobile device, detecting, by a vehicle speed detection device, a vehicle speed, determining, by a main control device, whether an emergency situation occurs based on the position change information of the mobile device and a change of the vehicle speed, and sending, by the main control device, an alarm signal from a vehicle when it is determined that the emergency situation has occurred.

The determining whether an emergency situation occurs may include detecting, by an airbag detection device, whether an airbag is deployed, when the airbag is deployed, determining, by the main control device, that the emergency situation has occurred, and when the airbag is not deployed, determining, by the main control device, that the emergency situation has occurred when the position change information of the mobile device is greater than or equal to a first predetermined threshold value and the change of the vehicle speed is greater than or equal to a second predetermined threshold value.

The emergency call method based on UWB may further include detecting, by a positioning device, position information of the vehicle, detecting, by a vehicle external temperature and humidity detection device, vehicle external temperature information and vehicle external humidity information, detecting, by an on-board camera, environment information around the vehicle, detecting, by a seat boarding detection device, information of the number of passengers, obtaining, by the main control device, at least one of the position information of the vehicle, the vehicle external temperature information, the vehicle external humidity information, the environment information around the vehicle, or the information of the number of passengers when it is determined that the emergency situation has occurred, and sending, by the on-vehicle UWB communication device, at least one of the obtained position information of the vehicle, the obtained vehicle external temperature information, the obtained vehicle external humidity information, the obtained environment information around the vehicle, or the obtained information of the number of passengers to the mobile device.

The emergency call method based on UWB may further include displaying, an on-board display device, prompt information about whether to make an emergency call to a driver when it is determined that the emergency situation has occurred, and when no emergency call is not selected within a predetermined time, allowing, by the main control device, the mobile device to send the emergency call to a rescue center together with at least one of the obtained vehicle position information, the obtained vehicle external temperature information, the obtained vehicle external humidity information, the obtained environment information around the vehicle, or the obtained information of the number of passengers.

The emergency call method based on UWB may further include when it is determined that the emergency situation has occurred, detecting, by the main control device, whether an audio device is operating, and when it is detected that the audio device is operating, turning off the audio device.

The emergency call method based on UWB may further include operating, by the main control device, at least one of a buzzer, a warning light, or a horn when it is determined that the emergency situation has occurred.

The on-vehicle UWB communication device may include a plurality of on-board UWB communication modules, the number of the plurality of on-board UWB communication modules may be five, and the five on-board UWB communication modules may be provided at a left front portion, a right front portion, a left rear portion, a right rear portion, and a position of a roof close to a front of the vehicle, respectively.

The present disclosure uses the above-described technical measures, and the beneficial effects are as follows.
1. Real-time positioning: Through the UWB technology of the vehicle, the position of the mobile device may be monitored in real time, thereby ensuring accurate acquisition of position change information of the mobile device in the emergency situation.
2. Quickly responding to emergency situation: When the position of the mobile device suddenly moves, the on-vehicle UWB communication device immediately detects the position change in the mobile device and sends the relevant information to the main control device of the vehicle. The main control device may combine the vehicle information with the relevant information to determine whether the emergency situation occurs, thereby more accurately determining whether the emergency situation occurs.
3. Providing alert and notification: when it is determined that the emergency situation has occurred, the main control device of the vehicle operates one of the alarm light, the horn, and the buzzer of the vehicle, and allows people around the vehicle to identify the condition of the vehicle and perform the corresponding rescue measure.
4. Automatic rescue request: when it is determined that the emergency situation has occurred, the emergency call system based on the UWB according to an embodiment of the present disclosure automatically sends the rescue request to the rescue center through the mobile device to ensure that the vehicle may be rescued in a timely manner.
5. Manual rescue request: when it is determined that the emergency situation has occurred, the emergency call system based on the UWB according to an embodiment of the present disclosure may display the prompt information to the driver through the on-board display device, and the driver may select whether to send the rescue request to the rescue center.
6. Providing main vehicle information: when it is determined that the emergency situation has occurred, the mobile device further sends the information corresponding to the position information of the vehicle, the weather information outside the vehicle, the environment information around the vehicle, and the information of the number of passengers, etc. when sending the emergency call to the rescue center so that the rescue center may accurately identify the condition of the vehicle.

In addition, the effects obtainable or predicted by the embodiments of the present disclosure are to be disclosed directly or implicitly in the detailed description of the embodiments of the present disclosure. That is, various effects predicted according to the embodiments of the present disclosure will be disclosed in the detailed description to be described later.

### BRIEF DESCRIPTION OF THE DRAWINGS

Hereinafter, the embodiments of the present disclosure will be described in more detail by referring to the accompanying drawings. For clarity, like components in different figures are denoted by like reference numerals. It should be noted that the drawings are merely schematic and are not drawn to scale.

FIG. 1 is a block diagram illustrating an emergency call system based on an ultra-wideband (UWB) according to an embodiment of the present disclosure.

FIG. 2 is a flowchart illustrating an emergency call method based on a UWB according to an embodiment of the present disclosure.

### DETAILED DESCRIPTION OF THE EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, the embodiments of the present disclosure will be described in detail. The present embodiments is implemented under the premise of the technical solution of the present disclosure, and the detailed embodiments and specific operation procedures are shown, but the protection scope of the present disclosure is not limited by the following embodiments.

Hereinafter, embodiments of the present disclosure will be described in detail with reference to the accompanying drawings.

According to the present disclosure, an emergency call system utilizes wireless technology, preferably ultra-wideband (UWB), which is a radio technology that uses signals having a low energy level and offers precise positioning and/or tracking, along with secure communications, thus enabling short-range, high-bandwidth communications over a large portion of the radio spectrum.

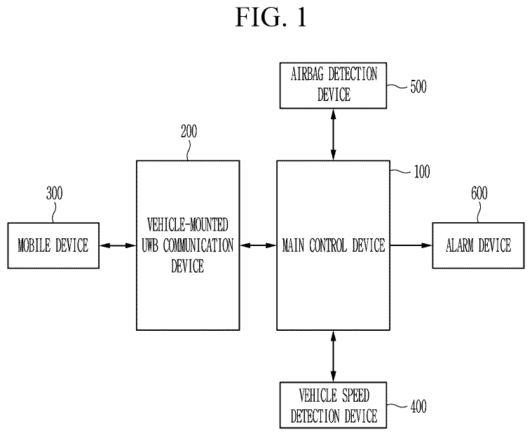

FIG. 1 is a block diagram illustrating an emergency call system based on an ultra-wideband (UWB) according to an embodiment of the present disclosure. The UWB-based emergency call system according to an embodiment of the present disclosure includes a main control device 100, an on-vehicle UWB communication device 200, a mobile device 300, and a vehicle speed detection device 400.

The mobile device 300 is provided with a UWB communication module and may transmit and receive UWB communication signals. The mobile device 300 may include any portable mobile device such as a mobile phone, a tablet PC, etc.

A UWB technology is a wireless communication technology that sends data using a narrow pulse at a nanosecond level. The UWB technology provides secure data communication at speeds of up to 27 Mbps by realizing precise positioning at the centimeter level, and has very low power consumption and delay. High bandwidth and low power spectrum density may share frequency spectrums with other narrowband and broadband wireless communication systems, and have constant anti-interference performance.

A UWB processing module and a plurality of on-board UWB communication modules may be provided to the on-vehicle UWB communication device 200. The UWB processing module may be connected to each of the plurality of on-board UWB communication modules through a wired communication manner. Each of the plurality of on-board UWB communication modules may be configured to perform UWB communication with the mobile device 300, and transmit the received UWB communication signal of the mobile device 300 to the UWB processing module. The UWB processing module may detect position information of the mobile device 300 based on the received UWB communication signal of the mobile device 300, determine position change information of the mobile device 300 based on the detected position information of the mobile device 300, convert the determined position change information of the mobile device 300 into an on-board communication signal, and transmit the on-board communication signal to the main control device 100.

The number of the plurality of on-board UWB communication modules may be 3, 4, 5, or 6 or more. According to an embodiment of the present disclosure, the number of the plurality of on-board UWB communication modules may be five including a slave on-board UWB communication module provided in front of the left side of a vehicle, a slave on-board UWB communication module provided in front of the right side, a slave on-board UWB communication module provided in rear of the left side, a slave on-board UWB communication module provided in rear of the right side, and a master on-board UWB communication module provided in a position on a roof close to the front of the vehicle. The arrangement of the plurality of on-board UWB communication modules is not limited thereto, and the plurality of on-board UWB communication modules may be arranged according to a vehicle structure and an actual need.

The plurality of on-board UWB communication modules may be communicatively connected to each other through a wired communication manner, and one or more of the plurality of on-board UWB communication modules may be communicatively connected to the main control device 100. According to an embodiment of the present disclosure, only the master on-board UWB communication module among the plurality of on-board UWB communication modules may be communicatively connected to the main control device 100, and the remaining slave on-board UWB communication modules may be communicatively connected to the master on-board UWB communication module.

In addition, one or more of the plurality of on-board UWB communication modules may perform communication authentication with the mobile device 300. According to an embodiment of the present disclosure, only the master on-board UWB communication module may be configured to communicatively authenticate with the mobile device 300, and the remaining slave on-board UWB communication modules may be configured to detect the position information of the mobile device 300.

The UWB technology may calculate a distance between a transmitter and a receiver by calculating a time difference of signal propagation, and for example, may calculate the distance between the transmitter and the receiver based on a signal propagation time and an existing signal propagation speed (generally the speed of light). Position change information within a specific time may be obtained by differentiating the measured distance twice in succession.

The vehicle speed detection device 400 (e.g., a wheel speed sensor, a vehicle speed sensor, etc.) may be configured to detect a vehicle speed and send the detected vehicle speed to the main control device 100. In addition, the vehicle speed detection device 400 is configured to detect a change of the vehicle speed, and send the change of the vehicle speed to the main control device 100.

The main control device 100 is communicatively connected to the on-vehicle UWB communication device 200 and the vehicle speed detection device 400 through a wired communication manner. The main control device 100 may be configured to determine whether an emergency situation occurs based on the position change information of the mobile device 300 and the change of the vehicle speed, and send an alarm signal from the vehicle when it is determined that the emergency situation has occurred. According to an embodiment of the present disclosure, the main control device 100 may be a body domain controller (BDC).

According to an embodiment of the present disclosure, the position change information of the mobile device 300 may include whether the position change information of the mobile device 300 is equal to or greater than a first predetermined threshold value. The first predetermined threshold value means a position change amount of the mobile device 300 during a specific period, and may be set within a range of 9 centimeters/0.1 seconds to 11 centimeters/0.1 seconds. According to an embodiment of the present disclosure, the first predetermined threshold value may be set to 10 centimeters/0.1 seconds, but this is merely an exemplary value, and may be adjusted according to an actual need, and the present disclosure is not limited to the above value.

The change of the vehicle speed may include whether the change of the vehicle speed is equal to or greater than a second predetermined threshold value. The second predetermined threshold value means a fast and slow degree of the vehicle speed that changes over time. When the vehicle speed greatly changes within a short time, the second predetermined threshold value may indicate that the vehicle is accelerating or decelerating. The second predetermined threshold value may be set within a range of 9 m/s² to 11 m/s². According to an embodiment of the present disclosure, the second predetermined threshold value may be set to 10 m/s², but this is merely an exemplary value, and may be adjusted according to an actual situation, and the present disclosure is not limited to the above value.

The emergency call system based on the UWB according to an embodiment of the present disclosure may further include an airbag detection device 500 that may be configured to detect whether an airbag is deployed. The airbag detection device 500 may include a collision sensor, a control module, an inflator, the airbag, etc. When the vehicle collides, a vehicle collision intensity signal is detected by the collision sensor and is input to the control module, and the control module determines whether to inject gas into the airbag by blowing a gas injection element according to the signal of the collision sensor, that is, determines whether the airbag is deployed, and sends the detected information about whether the airbag is deployed to the main control device 100.

The main control device 100 may be communicatively connected to the airbag detection device 500 through a wired communication manner. When the airbag is deployed, the main control device 100 may determine that the emergency situation has occurred. Also, when the airbag is not deployed, the main control device 100 may be configured to determine that the emergency situation has occurred when the position change information of the mobile device 300 is greater than or equal to the first predetermined threshold value and the change of the vehicle speed is greater than or equal to the second predetermined threshold value.

The emergency call system based on the UWB may further include an alarm device 600, and the alarm device 600 may include at least one of a buzzer, a warning lamp, or a horn electrically connected to the main control device 100. When it is determined that the emergency situation has occurred, the main control device 100 may operate at least one of the buzzer, the warning lamp, or the horn to send an alarm signal from the vehicle.

The emergency call system based on the UWB according to an embodiment of the present disclosure may monitor the position of the mobile device 300 in real time through the UWB technology of the vehicle, thereby accurately obtaining the position change information. When the position of the mobile device 300 suddenly moves (the mobile device 300 may suddenly be moved or be thrown out of the vehicle), the main control device 100 may determine whether the emergency situation occurs by further referring to vehicle information, thereby more accurately determining whether the emergency situation occurs. When it is determined that the emergency situation has occurred, the main control device 100 operates one of the alarm devices such as the alarm lamp, the horn, and the buzzer of the vehicle so that people around the vehicle may identify the condition of the vehicle and take appropriate rescue measures.

The emergency call system based on the UWB according to an embodiment of the present disclosure may further include a positioning device, a vehicle external temperature and humidity detection device, an on-board camera, and a seat boarding detection device.

The positioning device may be configured to detect a driving position of the vehicle and send the detected driving position of the vehicle to the main control device 100. A global positioning system (GPS) is a representative example of the positioning device. According to the current technology, the GPS may accurately calculate three-dimensional (3D) current position information according to latitude, longitude, and altitude by receiving signals from three or more satellites, considering accurate time information, then calculating distance information from the signals, and applying trigonometry to the calculated distance information. The positioning device may be included in an audio, video, navigation, and telematics (AVNT) device. The AVNT device may implement practical functions such as AI intelligent voice control, remote control, real-time mobile phone interconnection, GPS navigation, etc.

The vehicle external temperature and humidity detection device may be configured to detect temperature information of a vehicle external environment and humidity information of the vehicle external environment, and send the obtained temperature and humidity information of the vehicle external environment to the main control device 100. The vehicle external temperature and humidity detection device may be a single detection device or a plurality of detection devices. The vehicle external temperature and humidity detection device may be included in the AVNT device. Also, the temperature and humidity information of the vehicle external environment may be obtained using a wireless communication network through a wireless communication module. Here, the detected humidity of the vehicle external environment is the relative humidity, that is, a percentage of an actual water vapor density included in the air and a saturated vapor density at the same temperature.

According to an embodiment of the present disclosure, the wireless communication network may include a global system for mobile communication (GSM), a code division multiple access (CDMA), a wideband code division multiple access (WCDMA), a universal mobile telecommunication system (UMTS), a time division multiple access (TDMA), and a long-term evolution (LTE), but the present disclosure is not limited thereto.

The on-board camera may be configured to obtain environment information around the vehicle. According to a mounting position, the on-board camera may include a front camera, an around view camera, a rear camera, a side camera, an embedded camera, etc.

The seat boarding detection device may be configured to detect information of the number of passengers. The seat boarding detection device may be implemented through a pressure sensor, a weight sensor, or an image recognition technology. The sensor may estimate information such as the number of passengers in the vehicle and whether there is a person in a driver's seat, a passenger seat, and a rear seat by detecting a pressure value and weight of the seat, or may estimate information such as the number of passengers in the vehicle and whether there is a person in the driver's seat, the passenger seat, and the rear seat by analyzing images captured by the camera, and thus may feedback the information of the number of passengers in a timely manner, thereby improving driving safety. The information of the number of passengers may include information such as the number of passengers in the vehicle and whether there is a person in the driver's seat, the passenger seat, and the rear seat.

The main control device 100 may be communicatively connected to the positioning device, the vehicle external temperature and humidity detection device, and the on-board camera, and may be electrically connected to the seat boarding detection device. When it is determined that the emergency situation has occurred, the main control device 100 may obtain the vehicle position information, the vehicle external temperature information, the vehicle external humidity information, the environment information around the vehicle, and the information of the number of passengers, and the obtained vehicle position information, the obtained vehicle external temperature information, the obtained vehicle external humidity information, the obtained environment information around the vehicle, and the obtained information of the number of passengers are sent to the mobile device 300 by the on-vehicle UWB communication device 200.

According to an embodiment of the present disclosure, the main control device 100 may convert the obtained vehicle position information, the obtained vehicle external temperature information, the obtained vehicle external humidity information, the obtained environment information around the vehicle, and the obtained information of the number of passengers into the on-board communication signal and send the on-board communication signal to the on-vehicle UWB communication device 200, and the on-vehicle UWB communication device 200 may convert the received on-board communication signal into the UWB communication signal and then send the UWB communication signal to the mobile device 300.

According to an embodiment of the present disclosure, the emergency call system based on the UWB may further include an on-board display device, and the on-board display device may be communicatively connected to the main control device 100 through a wired communication manner. When it is determined that the emergency situation has occurred, the on-board display device may be configured to display prompt information (e.g., “Is an emergency rescue required?”) about whether to make an emergency call to a driver.

When no emergency call is not selected within a predetermined time, the main control device 100 may allow the mobile device 300 to send the emergency call to a rescue center and send the vehicle position information, the vehicle external temperature information, the vehicle external humidity information, the environment information around the vehicle, and the information of the number of passengers together to the rescue center. That is, the main control device 100 may send a control command requesting rescue to the mobile device 300 through the on-vehicle UWB communication device 200 so that the mobile device 300 may send the emergency call to the rescue center and send the vehicle information. According to an embodiment of the present disclosure, the predetermined time may be set to 30 seconds, 20 seconds, etc., but the present disclosure is not limited thereto. The rescue center may include several departments and organizations such as an emergency center, a police station, and a fire department, to provide comprehensive support in the emergency situation.

The on-board display device may be provided as an instrument panel, or may be provided as a flat panel display device such as a liquid crystal display (LCD), an organic light emitting diode (OLED), and a plasma display panel (PDP). The on-board display device may display the prompt information about whether to make the emergency call, and a button for selecting whether to make the emergency call may be provided to the on-board display device or may be provided at other positions such as a steering wheel, etc. but the present disclosure is not limited thereto.

According to an embodiment of the present disclosure, the on-board communication signal may include a wired communication signal. The wired communication manner may include a controller area network (CAN), a universal serial bus (USB), a high definition multimedia interface (HDMI), a digital visual interface (DVI), etc. Here, a CAN communication manner may include a powertrain CAN (P_CAN), a vehicle body control device CAN (B_CAN), a chassis control CAN (C_CAN), etc. However, the present disclosure is not limited to the communication manners.

The emergency call system based on the UWB according to an embodiment of the present disclosure may automatically send a rescue request to the rescue center through the mobile device 300 when it is determined that the emergency situation has occurred, thereby ensuring the rescue in a timely manner. In addition, the emergency call system based on the UWB according to an embodiment of the present disclosure may display the prompt information to the driver through an on-vehicle display device, and the driver may select whether to send the rescue request to the rescue center. In addition, the mobile device 300 may send the emergency call to the rescue center, and send the vehicle position information, the vehicle external temperature information, the vehicle external humidity information, the environment information around the vehicle, and the information of the number of passengers together to the rescue center, so that the rescue center may accurately identify the condition of the vehicle.

In addition, an on-vehicle audio device capable of playing audio may be mounted on the vehicle, and communicatively connected to the main control device 100. When it is determined that the emergency situation has occurred, the main control device 100 detects whether the audio device is operating, and when it is detected that the audio device is operating normally, the main control device 100 immediately turns off the audio device to ensure the call quality of the emergency call.

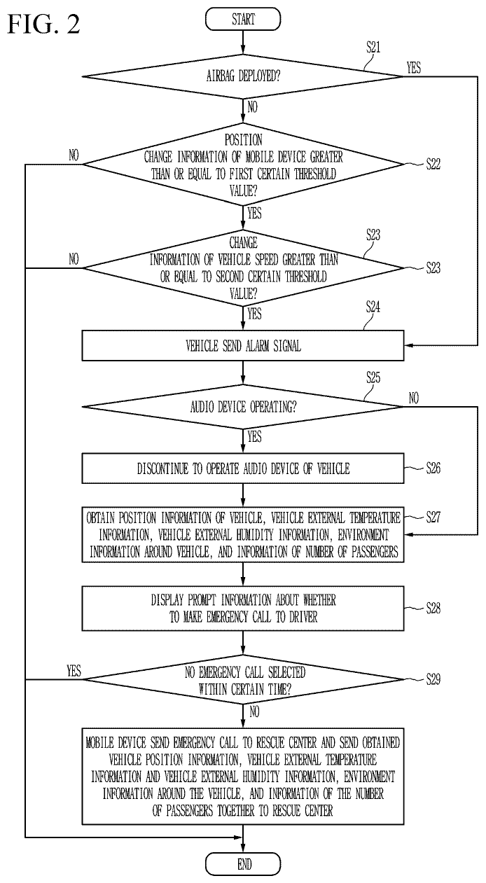

Hereinafter, an emergency call method based on the UWB will be described with reference to FIG. 2 by way of a specific example.

Referring to FIG. 2, in step S21, whether the airbag is deployed is detected by the airbag detection device. When the airbag is deployed (i.e., “Yes” in the step S21), the main control device may determine that the emergency situation has occurred, and in step S24, the vehicle sends the alarm signal to operate at least one of the buzzer, the warning lamp, or the horn.

When the airbag is not deployed, in step S22, it is determined whether the position change information of the mobile device is greater than or equal to the first predetermined threshold value by the on-vehicle UWB communication device, and in step S23, it is determined whether the change of the vehicle speed is greater than or equal to the second predetermined threshold value by the vehicle speed detection device. When the airbag is not deployed (i.e., “No” in the step S21), it is determined that the emergency situation has occurred when the position change information of the mobile device is greater than or equal to the first predetermined threshold value (i.e., “Yes” in the step S22), and the change of the vehicle speed is greater than or equal to the second predetermined threshold value (i.e., “Yes” in the step S23), and in the step S24, the vehicle sends the alarm signal to operate at least one of the buzzer, the warning lamp, or the horn.

According to an embodiment of the present disclosure, the first predetermined threshold value may be set to 10 cm/0.1 seconds, and the second predetermined threshold value may be set to 10 m/s², but the present disclosure is not limited to the above values.

When the audio device is installed in the vehicle, whether the audio device is operating is detected by the main control device in step S25. When it is detected that the audio device is operating (i.e., “Yes” in the step S25), the audio device is turned off in order to ensure the call quality of the emergency call in step S26.

In step S27, the position information of the vehicle, the vehicle external temperature information, the vehicle external humidity information, the environment information around the vehicle, and the information of the number of passengers are obtained. According to an embodiment of the present disclosure, the vehicle position information may be detected by the positioning device, the vehicle external temperature information and the vehicle external humidity information may be detected by the vehicle external temperature and humidity detection device, the environment information around the vehicle may be detected by the on-board camera, and the information of the number of passengers may be detected by the seat boarding detection device.

In step S28, the prompt information (e.g., “Is an emergency rescue required?”) about whether to make the emergency call to the driver is displayed by the on-board display device.

In step S29, it is determined whether no emergency call is selected within the predetermined time. According to an embodiment of the present disclosure, the predetermined time may be set to 30 seconds, 20 seconds, etc., but the present disclosure is not limited thereto.

When no emergency call is not selected within the predetermined time (i.e., “No” in the step S29), the mobile device sends the emergency call to the rescue center and sends the vehicle position information, the vehicle external temperature information, the vehicle external humidity information, the environment information around the vehicle, and the information of the number of passengers together to the rescue center by the main control device.

In addition, upon obtaining the information of the number of passengers in the vehicle, when it is detected that there is no person in the driver's seat, or when it is confirmed that there is no person in the driver's seat through the on-vehicle camera, this may mean that the driver has been thrown out of the vehicle. Correspondingly, the information of the number of passengers may include the information such as the number of passengers in the vehicle and whether there is a person in the driver's seat, the passenger seat, and the rear seat. Implementing the system and the method may improve a response speed and a structural efficiency to accident victims, thereby potentially saving lives and reducing the severity of accident outcomes.

The emergency call method based on the UWB according to an embodiment of the present disclosure detects a sudden movement of the mobile device in the vehicle detected through the UWB communication, and combines the vehicle information with the movement to determine whether the emergency situation occurs. When the emergency situation occurs, the vehicle sends the alarm signal. Also, the vehicle automatically requests an alarm and rescue by sending the relevant information to the mobile device, thereby effectively improving the safety of the vehicle and providing a more convenient and intelligent driving experience to the user.

The various embodiments of the present disclosure are not a complete list of all possible combinations, but are intended to illustrate representative aspects of the present disclosure, and the descriptions of various embodiments may be applied independently or in combination of two or more.

As described above, the description of the exemplary embodiments is merely for describing the technical solution of the present disclosure, is not intended to completely perfect the present disclosure, and is not intended to limit the present disclosure to the exact form described. It is obvious that one of ordinary skill in the art may have various modification and changes according to the above teaching. The exemplary embodiment was selected and explained by interpreting a specific principle of the present disclosure and its actual application so that one of ordinary skill in the art may easily understand and implement and use various exemplary embodiments and their various selective forms and modified forms. The scope of protection of the present disclosure is limited by the appended claims and their equivalents.

What is claimed is:

1. An emergency call system based on wireless technology, the emergency call system comprising:
a mobile device including a communication module and capable of transmitting and receiving a communication signal;
a vehicle including an on-vehicle communication device including a processing module and a plurality of on-board communication modules;
a vehicle speed detection device configured to detect a vehicle speed; and
a main control device communicatively connected to the on-vehicle communication device and the vehicle speed detection device,
wherein the main control device is configured to determine whether an emergency situation occurs based on position change information of the mobile device and a change of the vehicle speed, and send an alarm signal from the vehicle when it is determined that the emergency situation has occurred.

2. The emergency call system of claim 1, wherein:
the processing module is configured to be communicatively connected to the plurality of on-board communication modules, the plurality of on-board communication modules being configured to perform wireless communication with the mobile device, and sends the received communication signal of the mobile device to the processing module, the processing module being configured to detect position information of the mobile device based on the received communication signal of the mobile device, and determine the position change information of the mobile device according to the detected position information of the mobile device.

3. The emergency call system of claim 2, further comprising:
an airbag detection device communicatively connected to the main control device and configured to detect whether an airbag is deployed,
wherein the main control device is further configured to:
when the airbag is deployed, determine that the emergency situation has occurred; and
when the airbag is not deployed, determine that the emergency situation has occurred when the position change information of the mobile device is greater than or equal to a first predetermined threshold value and the change of the vehicle speed is greater than or equal to a second predetermined threshold value.

4. The emergency call system of claim 2, further comprising:
a positioning device configured to detect position information of the vehicle;
a vehicle external temperature and humidity detection device configured to detect vehicle external temperature information and vehicle external humidity information, respectively;
an on-board camera configured to detect environment information around the vehicle; and
a seat boarding detection device configured to detect information of the number of passengers,
wherein the main control device is communicatively connected to the positioning device, the vehicle external temperature and humidity detection device, and the on-board camera, and electrically connected to the seat boarding detection device, and
wherein the main control device is further configured to obtain at least one of the position information of the vehicle, the vehicle external temperature information, the vehicle external humidity information, the environment information around the vehicle, or the information of the number of passengers when it is determined that the emergency situation has occurred, and send at least one of the obtained position information of the vehicle, the obtained vehicle external temperature information, the obtained vehicle external humidity information, the obtained environment information around the vehicle, or the obtained information of the number of passengers to the mobile device by the on-vehicle communication device.

5. The emergency call system of claim 4, further comprising:
an on-board display device communicatively connected to the main control device and configured to display prompt information about whether to make an emergency call to a driver when it is determined that the emergency situation has occurred,
wherein, when no emergency call is not selected within a predetermined time, the main control device is further configured to allow the mobile device to send the emergency call to a rescue center and send at least one of the obtained vehicle position information, the obtained vehicle external temperature information, the obtained vehicle external humidity information, the obtained environment information around the vehicle, or the obtained information of the number of passengers together to the rescue center.

6. The emergency call system of claim 2, further comprising:
an audio device communicatively connected to the main control device and configured to play audio,
wherein, when it is determined that the emergency situation has occurred, the main control device is further configured to detect whether the audio device is operating, and when it is detected that the audio device is operating, turn off the audio device.

7. The emergency call system of claim 2, further comprising:
at least one of a buzzer, a warning lamp, or a horn electrically connected to the main control device,
wherein the main control device is further configured to operate at least one of the buzzer, the warning light, or the horn when it is determined that the emergency situation has occurred.

8. The emergency call system of claim 2, wherein:
the number of the plurality of on-board communication modules is five, and the five on-board communication modules are provided at a left front portion, a right front portion, a left rear portion, a right rear portion, and a position of a roof close to a front of the vehicle, respectively.

9. The emergency call system of claim 2, wherein:
a communicable connection includes a connection in a wired communication manner, and
the wired communication manner includes a controller area network (CAN), a universal serial bus (USB), and a digital visual interface (DVI).

10. The emergency call system of claim 1, wherein the wireless technology is ultra-wideband (UWB).

11. The emergency call system of claim 10, wherein the communication module is a UWB communication module, and the on-vehicle communication device is an on-vehicle UWB communication device.

12. The emergency call system of claim 1, wherein the vehicle speed detection device and the main control device are provided in the vehicle.

13. An emergency call method based on wireless technology, the emergency call method comprising:
transmitting and receiving, by a mobile device, a communication signal;
detecting, based on the received communication signal of the mobile device by an on-vehicle communication device provided in a vehicle, position information of the mobile device;
determining, by the on-vehicle communication device, position change information of the mobile device according to the detected position information of the mobile device;
detecting, by a vehicle speed detection device, a vehicle speed;
determining, by a main control device, whether an emergency situation occurs based on the position change information of the mobile device and a change of the vehicle speed; and
sending, by the main control device, an alarm signal from the vehicle when it is determined that the emergency situation has occurred.

14. The emergency call method of claim 13, wherein determining whether the emergency situation occurs includes:
detecting, by an airbag detection device, whether an airbag is deployed;
when the airbag is deployed, determining, by the main control device, that the emergency situation has occurred; and
when the airbag is not deployed, determining, by the main control device, that the emergency situation has occurred when the position change information of the mobile device is greater than or equal to a first predetermined threshold value and the change of the vehicle speed is greater than or equal to a second predetermined threshold value.

15. The emergency call method of claim 13, further comprising:
detecting, by a positioning device, position information of the vehicle;
detecting, by a vehicle external temperature and humidity detection device, vehicle external temperature information and vehicle external humidity information;
detecting, by an on-board camera, environment information around the vehicle;
detecting, by a seat boarding detection device, information of the number of passengers;
obtaining, by the main control device, at least one of the position information of the vehicle, the vehicle external temperature information, the vehicle external humidity information, the environment information around the vehicle, or the information of the number of passengers when it is determined that the emergency situation has occurred; and
sending, by the on-vehicle communication device, at least one of the obtained position information of the vehicle, the obtained vehicle external temperature information, the obtained vehicle external humidity information, the obtained environment information around the vehicle, or the obtained information of the number of passengers to the mobile device.

16. The emergency call method of claim 15, further comprising:
displaying, an on-board display device, prompt information about whether to make an emergency call to a driver when it is determined that the emergency situation has occurred; and
when no emergency call is not selected within a predetermined time, allowing, by the main control device, the mobile device to send the emergency call to a rescue center together with at least one of the obtained vehicle position information, the obtained vehicle external temperature information, the obtained vehicle external humidity information, the obtained environment information around the vehicle, or the obtained information of the number of passengers.

17. The emergency call method of claim 13, further comprising:
when it is determined that the emergency situation has occurred, detecting, by the main control device, whether an audio device is operating; and
when it is detected that the audio device is operating, turning off, by the main control device, the audio device.

18. The emergency call method of claim 13, further comprising:
operating, by the main control device, at least one of a buzzer, a warning light, or a horn when it is determined that the emergency situation has occurred.

19. The emergency call method of claim 13, wherein:
the on-vehicle communication device includes a plurality of on-board communication modules, the number of the plurality of on-board communication modules is five, and the five on-board communication modules are provided at a left front portion, a right front portion, a left rear portion, a right rear portion, and a position of a roof close to a front of the vehicle, respectively.

20. The emergency call method of claim 13, wherein the wireless technology is ultra-wideband (UWB).
